(19) United States
(12) Patent Application Publication
(10) Pub. No.: US 2025/0349148 A1
(43) Pub. Date: Nov. 13, 2025

(54) RECOGNITION PROCESSING APPARATUS, RECOGNITION PROCESSING METHOD, AND STORAGE MEDIUM FOR STORING PROGRAM

(71) Applicant: JVCKENWOOD Corporation, Yokohama-shI (JP)

(72) Inventor: Takuya OGURA, Yokohama-shi (JP)

(21) Appl. No.: 19/280,621

(22) Filed: Jul. 25, 2025

Related U.S. Application Data
(63) Continuation of application No. PCT/JP2024/002918, filed on Jan. 30, 2024.

(30) Foreign Application Priority Data
Feb. 7, 2023 (JP) 2023-016855
Apr. 18, 2023 (JP) 2023-067864

(51) Int. Cl. G06V 40/10; G06T 5/94; G06T 7/11; G06V 10/14; G06V 10/22; G06V 10/60

(52) U.S. Cl. CPC G06V 40/103; G06T 5/94; G06T 7/11; G06V 10/14; G06V 10/22; G06V 10/60; G06T 2207/10048

(57) ABSTRACT

A recognition processing apparatus includes: a video acquisition unit that acquires a video captured by an infrared camera; a high temperature region detection unit that detects a high temperature region included in the video; a first detection unit that detects a person outside the high temperature region in the video by using a first detection process; and a second detection unit that detects a person inside the high temperature region in the video by using a second detection process different from the first detection process.

### CROSS REFERENCE TO RELATED APPLICATION

This application is a continuation of application No. PCT/JP2024/002918, filed on Jan. 30, 2024, and claims the benefit of priority from the prior Japanese Patent Application No. 2023-016855, filed on Feb. 7, 2023 and the prior Japanese Patent Application No. 2023-067864, filed on Apr. 18, 2023, the entire contents of which are incorporated herein by reference.

### BACKGROUND

### 1. Technical Field

The present disclosure relates to a recognition processing apparatus, a recognition processing method, and a storage medium for storing a program.

### 2. Description of the Related Art

A technology for detecting an object such as a pedestrian from an image capturing a scene around a vehicle by using image recognition technology such as pattern matching is known. For example, a technology for detecting a person included in a video captured by an infrared camera by pattern matching using a recognition dictionary has been proposed (see, for example, Patent Literature 1).
[Patent Literature 1] JP2022-017871A

In the case that a high temperature object is located in the background of a person included in a video captured by an infrared camera, the person may not be detected properly in some cases.

### SUMMARY

A recognition processing apparatus according to an embodiment of the present disclosure includes: a video acquisition unit that acquires a video captured by an infrared camera; a high temperature region detection unit that detects a high temperature region included in the video; a first detection unit that detects a person outside the high temperature region in the video by using a first detection process; and a second detection unit that detects a person inside the high temperature region in the video by using a second detection process different from the first detection process.

Another embodiment of the present disclosure relates to an image recognition processing method. The method includes: acquiring a video captured by an infrared camera; detecting a high temperature region included in the video; and detecting a person by using a first detection process outside the high temperature region in the video and detecting a person by using a second detection process different from the first detection process inside the high temperature region in the video.

Another embodiment of the present disclosure relates to a non-transitory recording medium storing a program. The method includes processor-implemented modules including: a module that acquiring a video captured by an infrared camera; a module that detects a high temperature region included in the video; a module that detects a person by using a first detection process outside the high temperature region in the video and detects a person by using a second detection process different from the first detection process inside the high temperature region in the video.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram schematically showing a functional configuration of a recognition processing apparatus according to the first embodiment;

FIG. 2 shows an example of a plurality of divided regions set in a video;

FIG. 3 shows an exemplary result of detection of high temperature regions included in the video;

FIGS. 4A, 4B, 4C, and 4D show examples of first person images;

FIGS. 5A, 5B, 5C, and 5D show examples of second person images;

FIG. 6 shows an exemplary result of detection of persons included in the video;

FIG. 7 is a flowchart showing an example of the flow of the recognition processing method according to the first embodiment;

FIG. 8 is a block diagram schematically showing a functional configuration of a recognition processing apparatus according to the second embodiment;

FIG. 9 is a block diagram schematically showing a functional configuration of a recognition processing apparatus according to the third embodiment; and

FIG. 10 is a block diagram schematically showing a functional configuration of a recognition processing apparatus according to the fourth embodiment.

### DETAILED DESCRIPTION

The invention will now be described by reference to the preferred embodiments. This does not intend to limit the scope of the present invention, but to exemplify the invention.

A description will be given below of embodiments of the present disclosure with reference to the drawings. Specific numerical values shown in the embodiments are by way of example only to facilitate the understanding of the invention and should not be construed as limiting the disclosure unless specifically indicated as such. Those elements in the drawings are not directly relevant to the present disclosure are omitted from the illustration.

### First Embodiment

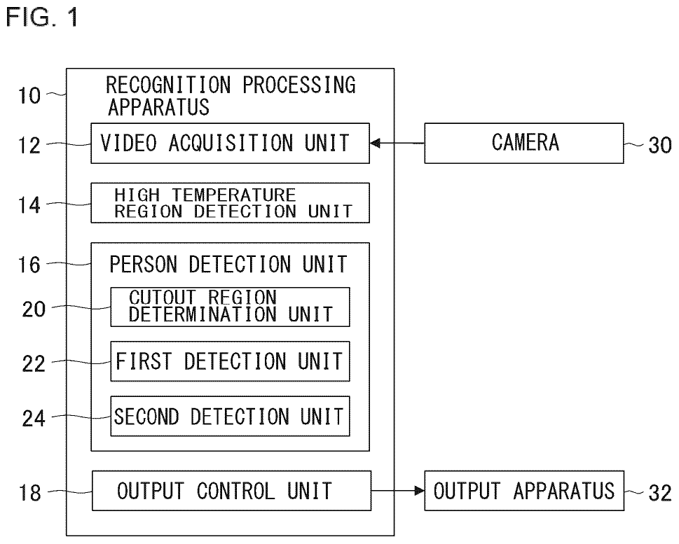

FIG. 1 is a block diagram schematically showing a functional configuration of a recognition processing apparatus 10 according to the first embodiment. The recognition processing apparatus 10 includes a video acquisition unit 12, a high temperature region detection unit 14, and a person detection unit 16. The recognition processing apparatus 10 may further include an output control unit 18. The recognition processing apparatus 10 is mounted on, for example, a moving object such as a vehicle to detect a person such as a pedestrian around the vehicle.

In this embodiment, an example will be shown in which the recognition processing apparatus 10 is mounted on a vehicle. The recognition processing apparatus 10 may be mounted on a flying object such as a drone. The recognition processing apparatus 10 may be fixed at a predetermined location instead of a moving object. The recognition processing apparatus 10 may be provided on a smart pole. The smart pole is installed on a street and includes, for example, an antenna and a communication device for providing a wireless communication function, a lighting device for illuminating the street, and a camera for photographing vehicles and pedestrians passing on the road.

The functional blocks presented in this embodiment are implemented by coordination of hardware and software. The hardware of the recognition processing apparatus 10 is implemented by devices and mechanical apparatus exemplified by a processor such as a CPU (Central Processing Unit) and a GPU (Graphics Processing Unit) of a computer and by a memory such as a ROM (Read Only Memory) and a RAM (Random Access Memory) of a computer. The software of the recognition processing apparatus 10 is implemented by a computer program, etc.

The video acquisition unit 12 acquires a video captured by a camera 30. The camera 30 is mounted on the moving object and captures an image of a scene around the moving object. The camera 30 captures, for example, an image of a scene in front of the moving object. The camera 30 may capture an image of a scene behind the moving object or capture an image of a scene beside the moving object. The recognition processing apparatus 10 may or may not include the camera 30.

The camera 30 is an infrared camera configured to capture infrared rays. The camera 30 is a so-called infrared thermography camera, which allows the temperature distribution around the moving object to be imaged and allows the heat source located around the moving object to be identified. The camera 30 may be configured to detect mid-infrared rays with a wavelength of about 2 μm-5 μm or to detect far-infrared rays with a wavelength of about 8 μm-14 μm. In this embodiment, the camera 30 will be described as a camera that captures a thermal image by far-infrared rays. The video captured by the camera 30 is, for example, moving images of 30 frames per second.

The high temperature region detection unit 14 detects a high temperature region included in the video acquired by the video acquisition unit 12. The high temperature region is a region that includes a high temperature object in the thermal image captured by the camera 30 having a luminance value equal to or greater than a predetermined threshold value. “High temperature” in this case refers to a temperature equal to or higher than the body temperature of a person. For example, it refers to a temperature of 30° C. or higher, 35° C. or higher, or 40° C. or higher. “High temperature object” refers to an object with a high temperature different from a person. For example, it refers to a high temperature object having a larger size than a person. An example of a high temperature object is the exterior wall of a building. The exterior wall of a building becomes a high temperature object when, for example, heated by sunlight. The high temperature region detection unit 14 may detect a high temperature portion or range on the ground, the road surface, etc. as a high temperature region (or a high temperature object) or may detect a range including a plurality of high temperature objects as a high temperature region.

For example, the high temperature region detection unit 14 sets a plurality of divided regions in the video acquired by the video acquisition unit 12 and determines whether a divided region is a high temperature region by using the luminance value in the divided region. For example, the high temperature region detection unit 14 may calculate a representative value such as an average value or a median value of the luminance value in the divided region and determine that the divided region in which the representative value is equal to or greater than a predetermined threshold value is a high temperature region. The high temperature region detection unit 14 may calculate the proportion of pixels in the divided region having a luminance value equal to or greater than a predetermined threshold value and determine the divided region in which the proportion of pixels having a high luminance value is a predetermined value (e.g., 30% or 50%) or higher as a high temperature region.

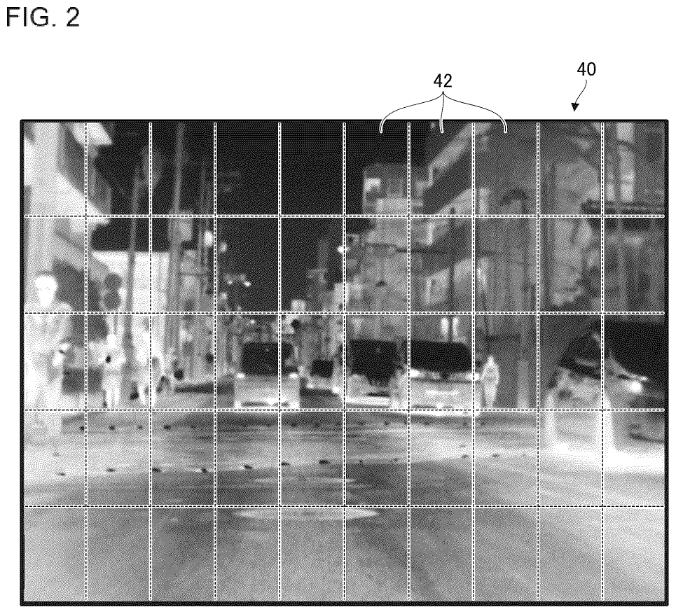

FIG. 2 shows an example of a plurality of divided regions 42 set in a video 40. In the example of FIG. 2, the video is divided into 10 regions in the horizontal direction and 5 regions in the vertical direction, resulting in 10×5=50 divided regions 42. The number of divisions to result in the plurality of divided regions 42 is not particularly limited and is arbitrary. The size of the plurality of divided regions 42 is set to be larger than, for example, the minimum size of the person detectable by the person detection unit 16. The plurality of divided regions 42 are set to have, for example, a rectangular shape elongated in the vertical direction and short in the horizontal direction. The plurality of divided regions 42 may be set such that the size of each divided region 42 is uniform or may be set unevenly such that the size varies according to the position of each divided region 42.

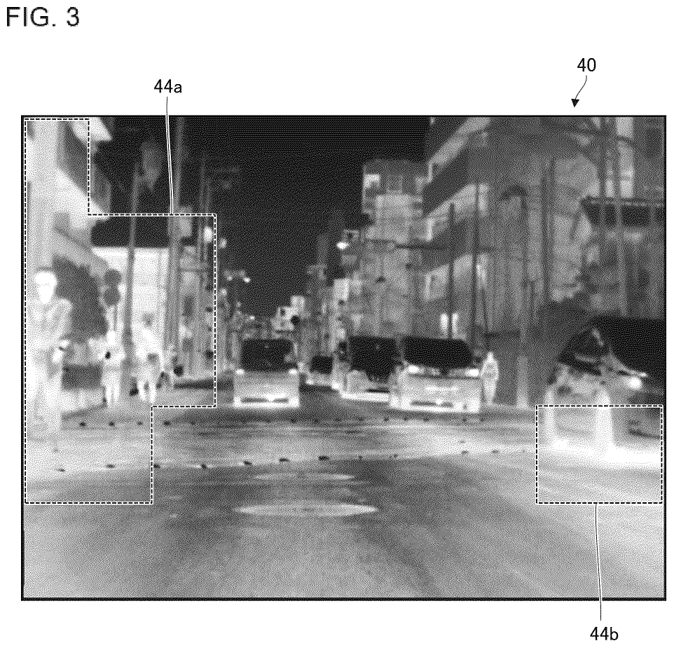

FIG. 3 shows an exemplary result of detection of high temperature regions 44a, 44b included in the video 40. The example of FIG. 3 shows a first high temperature region 44a detected on the left side of the video 40 and a second high temperature region 44b detected on the lower right side of the video 40. The first high temperature region 44a is detected as a high temperature region because the exterior wall of a building having a large size in the video 40 has a high temperature due to irradiation with sunlight or heat storage after irradiation with sunlight. The second high temperature region 44b is detected as a high temperature region due to the high temperature of a tire or a power source of a running automobile having a large size in the video 40.

In the case that the recognition processing apparatus 10 is mounted on a moving object such as a vehicle, the high temperature region in the shooting range of the camera 30 moves in association with the running or movement of the moving object. In this case, the high temperature region detection unit 14 may perform a process of tracking the high temperature region detected from the video acquired by the video acquisition unit 12 (or the divided region detected as a high temperature region) according to the movement of the moving body.

Returning to FIG. 1, the person detection unit 16 detects a region including a person in the video acquired by the video acquisition unit 12. The person detection unit 16 cuts out a partial region in the video acquired by the video acquisition unit 12 and calculates a recognition score indicating the possibility that a person is included in the partial region thus cut out (also referred to as a cutout region). The recognition score is calculated in the range of, for example, 0-1. The higher the probability that a person is included in the cutout region, the larger the value (i.e., a value close to 1), and the lower the probability that a person is included in the cutout region, the smaller the value (i.e., a value close to 0). When the recognition score is equal to or greater than a predetermined reference value, the person detection unit 16 detects a person in the cutout region.

The person detection unit 16 includes a cutout region determination unit 20, a first detection unit 22, and a second detection unit 24. The cutout region determination unit 20 determines whether the cutout region subject to detection of a person is outside a high temperature region or inside a high temperature region. The first detection unit 22 detects a person by the first detection process. The first detection unit 22 detects a person included in the cutout region determined to be outside a high temperature region by the cutout region determination unit 20. The second detection unit 24 detects a person by the second detection process different from the first detection process. The second detection unit 24 detects a person included in the cutout region determined to be inside a high temperature region by the cutout region determination unit 20.

The cutout region determination unit 20 determines whether the cutout region in the video is outside a high temperature region or inside a high temperature region based on the high temperature region detected by the high temperature region detection unit 14. The cutout region determination unit 20 determines that the cutout region is outside a high temperature region in the case that the cutout region does not overlap the high temperature region at all. The cutout region determination unit 20 determines that the cutout region is inside a high temperature region in the case that the entire cutout region overlaps the high temperature region. When the cutout region partially overlaps a high temperature region, i.e., when the cutout region extends inside and outside a high temperature region, the cutout region determination unit 20 determines that the cutout region is either outside the high temperature region or inside the high temperature region depending on the manner of overlapping between the cutout region and the high temperature region.

The cutout region determination unit 20 may determine whether the cutout region is inside a high temperature region based on the proportion of the area of the cutout region overlapping the high temperature region. The cutout region determination unit 20 may determine that the cutout region is inside the high temperature region when, for example, the proportion of the area of the cutout region overlapping the high temperature region is a predetermined value (e.g., 50% or 30%) or greater. The cutout region determination unit 20 may make a determination based on the position where the cutout region and the high temperature region overlap. For example, the cutout region determination unit 20 may determine that the cutout region is inside the high temperature region when the upper end or the lower end of the cutout region overlaps the high temperature region and determine that the cutout region is outside the high temperature region when neither the upper end nor the lower end of the cutout region overlaps the high temperature region. The first detection unit 22 detects a person by using the first person detection model generated by machine learning that uses the first person image that does not include a high temperature object in the background of the person as the correct answer image. Therefore, the first detection process can be said to be a person detection process using the first person detection model. The first person image is an image including a full-body image of a person and is an image in which a high temperature object is not located in the background of the person.

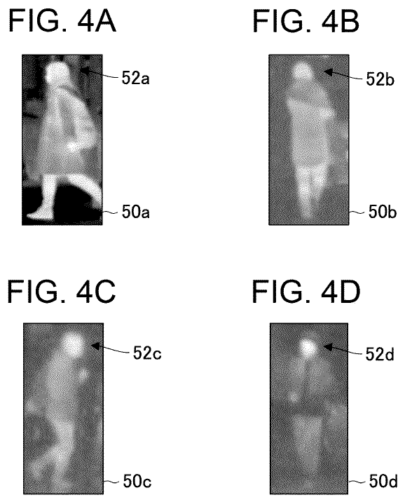

FIGS. 4A-4D show examples of first person images 50a, 50b, 50c, 50d. The first person images 50a-50d include full-body images of persons 52a, 52b, 52c, 52d, respectively. The first person images 50a-50d are cut out to result in, for example, a vertically elongated rectangular image in which the vertical and horizontal image sizes have a proportion of about 2:1. The first person images 50a-50d do not include a high temperature object as the background of the persons 52a-52d. In other words, a high-luminance object having a luminance equal to or greater than that of the high-luminance portion (head, hand, leg, etc.) of the persons 52a-52d is not included in the background of the first person images 50a-50d. Since a high-luminance object is not included in the background of the first person images 50a-50d, it can be said that the first person images 50a-50d are person images in which it is easy to distinguish between the persons 52a-52d and the background.

The second detection unit 24 detects a person by using the second person detection model generated by machine learning that uses the second person image that includes a high temperature object in the background of the person as the correct answer image. Therefore, the second detection process can be said to be a person detection process using the second person detection model. The second person image is an image including a full-body image of a person and is an image in which a high temperature object is located in the background of the person. The second person image differs from the first person image in that a high temperature object is located in the background of the person.

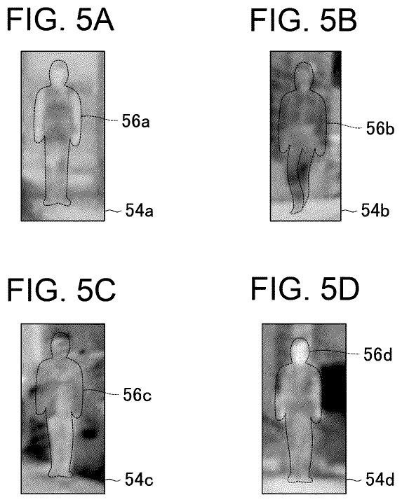

FIGS. 5A-5D show examples of second person images 54a, 54b, 54c, 54d. The second person images 54a-54d include full-body images of persons 56a, 56b, 56c, 56d indicated by dashed lines, respectively. Like the first person images 50a-50d, the second person images 54a-54d are cut out to result in, for example, a vertically elongated rectangular image in which the vertical and horizontal image sizes have a proportion of 2:1. The second person images 54a-54d include a high temperature object as the background of the persons 56a-56d. In other words, a high-luminance object having a luminance close to that of the high-luminance portion (head, hand, leg, etc.) of the persons 56a-56d or a high-luminance object having a luminance equal to or greater than that of the high-luminance portion of the persons 56a-56d is included in the background of the second person images 54a-54d. The high temperature object included in the second person images 54a-54d is located in at least one of on the upper side, the lower side, the left side and the right side of the persons 56a-56d, respectively. Since a high-luminance object is included in the background of the second person images 54a-54d, it can be said that the second person images 54a-54d are person images in which it is not easy to distinguish between the persons 56a-56d and the background.

The model used for machine learning can include an input corresponding to the image size (number of pixels) of an input image, an output that outputs a recognition score, and an intermediate layer that connects the input and the output. The intermediate layer can include a convolutional layer, a pooling layer, a fully connected layer, etc. The intermediate layer may have a multilayer structure and may be configured to enable deep learning. The model used for machine learning may be built by using a convolutional neural network (CNN). The model used for machine learning is not limited to the one described above, and any machine learning model may be used.

As in the examples shown in FIG. 4A-4D, the first person detection model is generated by using the first person image that does not include a high temperature object in the background. Therefore, the first person detection model has a high accuracy of detecting a situation in which a high temperature object is not included in the background, i.e., a person located outside a high temperature region. The first person detection model tends to be less accurate in detecting a situation in which a high temperature object is included in the background, i.e., a person located inside a high temperature region. On the other hand, the second person detection model is generated by using the second person image like those in the examples shown in FIGS. 5A-5D that includes a high temperature object in the background. Therefore, the second person detection model has a high accuracy of detecting a situation in which a high temperature object is included in the background, i.e., a person located inside a high temperature region. The second person detection model tends to be less accurate in detecting a situation in which a high temperature object is not included in the background, i.e., a person located outside a high temperature region.

The first person detection model can be generated by machine learning that does not use the second person image that includes a high temperature object in the background as the correct answer image. The second person detection model can be generated by machine learning that does not use the first person image that does not include a high temperature object in the background as the correct answer image.

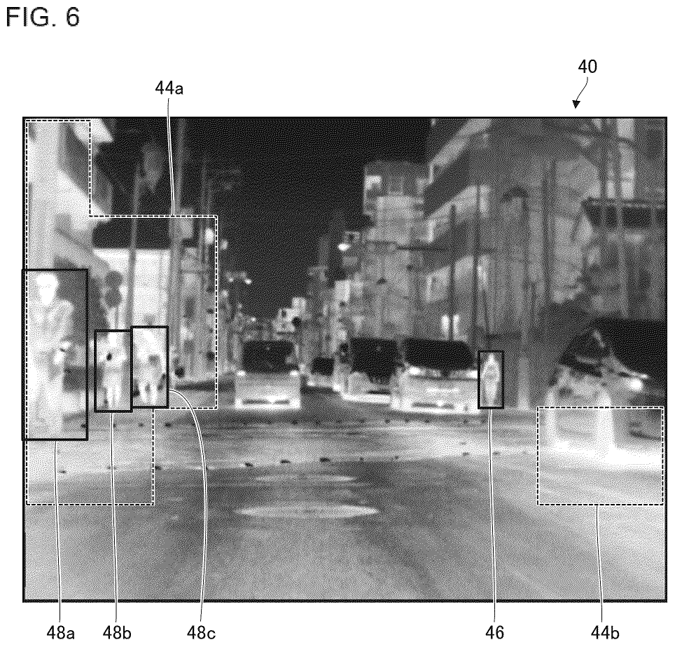

FIG. 6 shows an exemplary result of detection of persons 46, 48a, 48b, 48c included in the video 40. In the example of FIG. 6, the first person 46 outside the first high temperature region 44a and the second high temperature region 44b and the second persons 48a, 48b, 48c inside the first high temperature region 44a are detected.

In the example of FIG. 6, the cutout region determination unit 20 determines that the cutout region including the first person 46 is outside a high temperature region. This is because the cutout region including the first person 46 does not overlap either the first high temperature region 44a or the second high temperature region 44b detected by the high temperature region detection unit 14. The cutout region determination unit 20 determines that the cutout region including each of the second persons 48a-48c is inside a high temperature region. This is because the cutout region including each of the second persons 48a-48c overlaps the first high temperature region 44a in its entirety.

In the example of FIG. 6, the first detection unit 22 detects the first person 46 included in the cutout region determined to be outside a high temperature region by the cutout region determination unit 20. Since the first detection unit 22 uses the first person detection model trained by machine learning that uses the first person image not including a high temperature object in the background, the first detection unit 22 can detect the first person 46 for which a high temperature object is not included in the background with high accuracy.

In the example of FIG. 6, the second detection unit 24 detects the second persons 48a, 48b, 48c included in the cutout region determined to be inside a high temperature region by the cutout region determination unit 20. Since the second detection unit 24 uses the second person detection model trained by machine learning that uses the second person image including a high temperature object in the background, the second detection unit 24 can detect the second persons 48a, 48b, 48c for which a high temperature object is included in the background with high accuracy.

Returning to FIG. 1, the output control unit 18 causes the output apparatus 32 to output a result of person detection by the person detection unit 16. For example, the output control unit 18 generates a presentation video derived from attaching a result of person detection by the person detection unit 16 to the video acquired by the video acquisition unit 12 and causes the output apparatus 32 to output the presentation video thus generated. The output apparatus 32 is a display apparatus including an image display element exemplified by a liquid crystal display (LCD; Liquid Crystal Display) and an organic electroluminescent display (OELDs; Organic Electro Luminescence Display). The output apparatus 32 is provided in, for example, a moving object. In the case that the moving object is a vehicle, for example, the display apparatus is disposed at a position that can be seen by the driver of the vehicle. The output apparatus 32 may be a communication apparatus that outputs a result of person detection by the person detection unit 16 or a wireless communication apparatus that outputs a person detection result by road-to-vehicle communication or vehicle-to-vehicle communication. The output content of the output apparatus 32 may be whether a person is detected by the person detection unit 16, the position of the detected person, the number of detected persons, etc. The recognition processing apparatus 10 may or may not include the output apparatus 32.

The output control unit 18 generates a presentation video by, for example, superimposing an additional image such as a frame image for indicating a region that includes the person detected by the person detection unit 16 on the video. The output control unit 18 adds the first additional image to the person detected by the first detection unit 22 and adds the second additional image to the person detected by the second detection unit 24. The display mode of the first additional image may be the same as the display mode of the second additional image.

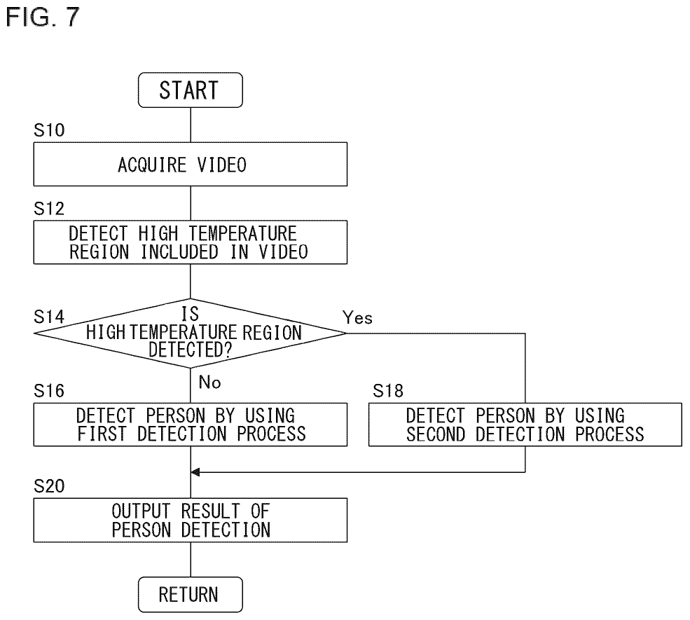

FIG. 7 is a flowchart showing an example of the flow of the recognition processing method according to the first embodiment. The video acquisition unit 12 acquires the video captured by the camera 30 (step S10). The high temperature region detection unit 14 detects a high temperature region included in the acquired video (step S12) and determines whether a high temperature region is detected (step S14). When a high temperature region is not detected (No in step S14), the person detection unit 16 detects a person in the video by using the first detection process performed by the first detection unit 22 (step S16). When a high temperature region is detected (Yes in step S14), the person detection unit 16 detects a person in the video by using the second detection process performed by the second detection unit 24 (step S18). The output control unit 18 causes the output apparatus 32 to output results of person detection by the first detection unit 22 and the second detection unit 24 (step S20). The process from steps S10 to S20 is repeatedly performed while the recognition processing apparatus 10 is operating or while the video is being captured by the camera 30.

In step S14 of the flowchart of FIG. 7, it may be determined whether a high temperature region is detected in a partial range in the video. In this case, given that a high temperature region is detected in a partial range in the video (Yes in step S14), the person detection unit 16 may detect a person by using the first detection process that uses the first detection unit 22 outside the high temperature region and may detect a person by using the second detection process that uses the second detection unit 24 inside the high temperature region. When a high temperature region is not detected in the video in step S14 (No in step S14), a person may be detected by using the first detection process that uses the first detection unit 22 in the entirety of the video (i.e., the entire region).

According to this embodiment, the accuracy of detection of a person located inside a high temperature region can be improved in the case that the video includes a high temperature region. Since the first person detection model is generated by machine learning that uses the first person image that does not include a high temperature object in the background, there is a problem that the accuracy of detection of a person located inside a high temperature region is low. According to this embodiment, the accuracy of detection of a person located inside a high temperature region can be improved by using the second person detection model generated by machine learning that uses the second person image including a high temperature object in the background. According to this embodiment, the accuracy of detection of a person located outside a high temperature region can be improved as compared to the case of using the second person detection model, by using the first person detection model to detect a person located outside a high temperature region.

### Second Embodiment

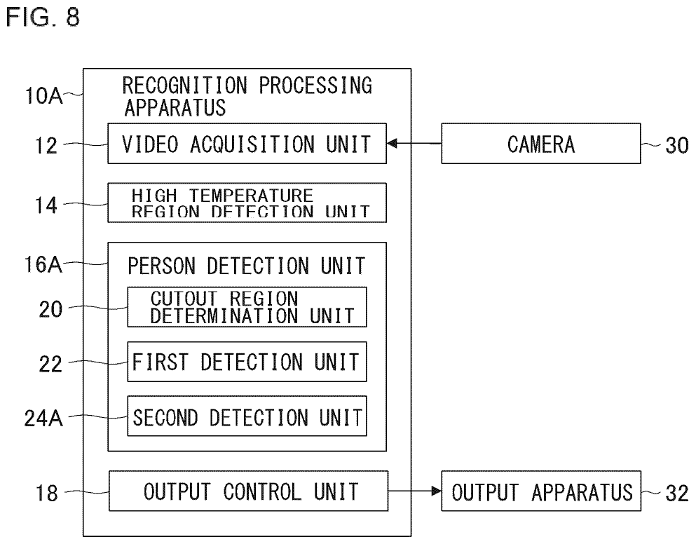

FIG. 8 is a block diagram schematically showing a functional configuration of a recognition processing apparatus 10A according to the second embodiment. The second embodiment differs from the first embodiment in that a second detection unit 24A uses the first person detection model instead of the second person detection model. The following description of the second embodiment highlights the difference from the first embodiment. A description of common features is omitted as appropriate.

The recognition processing apparatus 10A includes a video acquisition unit 12, a high temperature region detection unit 14, and a person detection unit 16A. The recognition processing apparatus 10A may further include an output control unit 18. The video acquisition unit 12, the high temperature region detection unit 14, and the output control unit 18 are configured in the same manner as in the first embodiment.

The person detection unit 16A includes a cutout region determination unit 20, a first detection unit 22, and a second detection unit 24A. The cutout region determination unit 20 and the first detection unit 22 are configured in the same manner as in the first embodiment.

The second detection unit 24A detects a person by the second detection process different from the first detection process. The second detection unit 24A detects a person included in the cutout region determined to be inside a high temperature region by the high temperature region detection unit 14. The second detection unit 24A detects a person by using the first person detection model generated by machine learning that uses the first person image that does not include a high temperature object in the background of the person as the correct answer image. The second detection unit 24A applies an image process that enhances the contrast in the high temperature region in the acquired video and detects a person included in the video subjected to the image process by using the first person detection model. Therefore, the second detection process differs from the first detection process in that an image process is applied to the acquired video.

The image process by the second detection unit 24A is performed so that, for example, the contrast in the high temperature region is greater, and the contrast outside the high temperature region is smaller. For example, contrast adjustment is performed so that the luminance difference between the person included in the acquired video and the high temperature object is increased. By adjusting the contrast so that the luminance difference between the person and the high temperature object is increased, it is easy to distinguish between the person and the high temperature object and the accuracy of detection of a person located in a high temperature region can be improved even when the first person detection model is used. The second detection unit 24A may apply an image process different from contrast adjustment or may apply an image process such as edge enhancement. The second detection unit 24A may apply an image process combining contrast adjustment and edge enhancement.

In this embodiment, too, the accuracy of detection of a person located in a high temperature region can be improved in the case that the video includes a high temperature region. According to this embodiment, distinction between a person and a high temperature object is facilitated and the accuracy of detection of a person located in a high temperature region can be increased, by detecting a person located in a high temperature region by using the video to which an image process such as contrast adjustment is applied. On the other hand, a decrease in accuracy of detection of a person not located in a high temperature region due to an image process is restricted by not applying an image process such as contrast adjustment.

### Third Embodiment

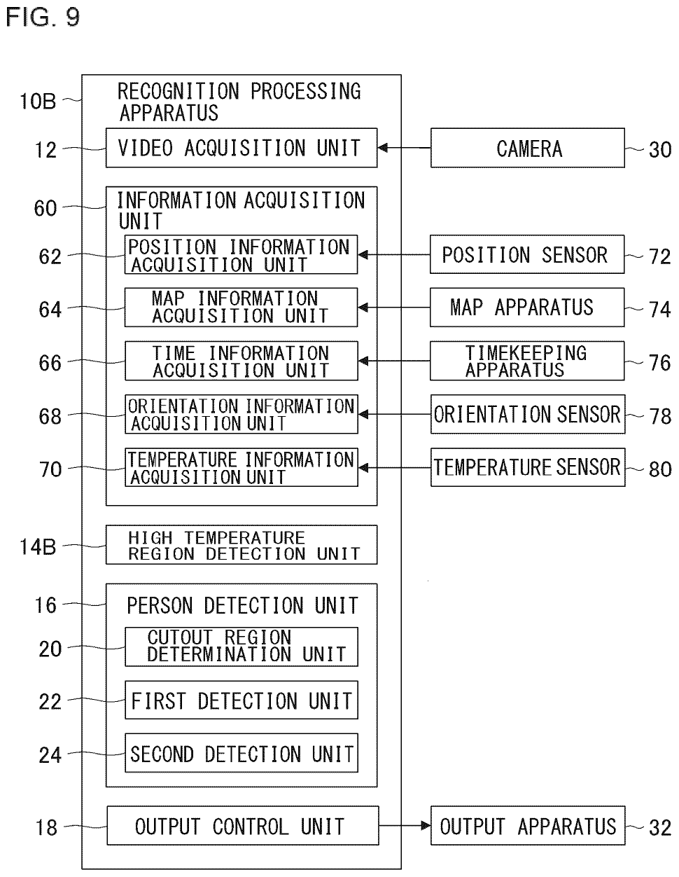

FIG. 9 is a block diagram schematically showing a functional configuration of a recognition processing apparatus 10B according to the third embodiment. The third embodiment differs from the first and second embodiments described above in that the recognition processing apparatus 10B further includes an information acquisition unit 60 and detects a high temperature region by using information acquired by the information acquisition unit 60. The following description of the third embodiment highlights the difference from the foregoing embodiments. A description of common features is omitted as appropriate.

The recognition processing apparatus 10B includes a video acquisition unit 12, an information acquisition unit 60, a high temperature region detection unit 14B, and a person detection unit 16. The recognition processing apparatus 10B may further include an output control unit 18. The video acquisition unit 12, the person detection unit 16, and the output control unit 18 are configured in the same manner as in the first embodiment. The person detection unit 16 may be configured in the same manner as the person detection unit 16A according to the second embodiment.

The information acquisition unit 60 may include a position information acquisition unit 62. The position information acquisition unit 62 acquires position information obtained by a position sensor 72. The position sensor 72 is mounted on the moving object and measures the position of the moving object. The position sensor 72 is, for example, a GNSS (Global Navigation Satellite System reception module, etc. The position sensor 72 detects the position of the recognition processing apparatus 10B, i.e., the imaging position of the camera 30. The recognition processing apparatus 10B may or may not be configured to include the position sensor 72.

The information acquisition unit 60 may include a map information acquisition unit 64. The map information acquisition unit 64 acquires map information from a map apparatus 74. The map apparatus 74 is an apparatus for storing map information and is, for example, a navigation apparatus. The map information includes information indicating the location, shape, and height of a building that could be a high temperature object. The recognition processing apparatus 10B may or may not be configured to include the map apparatus 74. The map information acquisition unit 64 may acquire the map information from an external server, etc. by using a wireless communication function (not shown).

The information acquisition unit 60 may include a time information acquisition unit 66. The time information acquisition unit 66 acquires time information from a timekeeping apparatus 76. The timekeeping apparatus 76 is, for example, a clock apparatus that generates current time information indicating the current date and time. The timekeeping apparatus 76 outputs the date and time of imaging by the camera 30. The recognition processing apparatus 10B may or may not be configured to include the timekeeping apparatus 76.

The information acquisition unit 60 may include an orientation information acquisition unit 68. The orientation information acquisition unit 68 acquires orientation information measured by an orientation sensor 78. The orientation sensor 78 is mounted on the moving body and measures the orientation of the moving object. The orientation sensor 78 is, for example, an acceleration sensor or a gyro sensor and detects the orientation or bearing of the moving object. The orientation sensor 78 detects, for example, the imaging direction of the camera 30. The recognition processing apparatus 10B may or may not be configured to include the orientation sensor 78.

The information acquisition unit 60 may include a temperature information acquisition unit 70. The temperature information acquisition unit 70 acquires temperature information measured by the temperature sensor 80. The temperature sensor 80 is mounted on the moving body and measures the temperature outside the moving object. The recognition processing apparatus 10B may or may not include the temperature sensor 80. The temperature information acquisition unit 70 may acquire temperature information such as the air temperature at the current position from an external server, etc. by using a wireless communication function (not shown).

The high temperature region detection unit 14B estimates a high temperature region including a high temperature object in the video acquired by the video acquisition unit 12 by using the information acquired by the information acquisition unit 60. The high temperature region detection unit 14B detects a high temperature region included in the video by using at least one of the position information, the map information, the time information, the orientation information, or the temperature information.

The high temperature region detection unit 14B identifies, for example, a building that could be a high temperature object located around the current imaging position by using the position information and the map information. The high temperature region detection unit 14B further uses the orientation information to identify a structure included in the angle of view of the camera 30. The high temperature region detection unit 14B further uses the time information to determine whether the building included in the angle of view of the camera 30 is a high temperature object.

The conditions that make a building a high temperature object include the temperature and the daylight hours determined by the season. Given that the season is summer, for example, it is assumed that the temperature of a building will be 30° C. or higher both during the day and at night so that the building represents a high temperature object. Given that the season is spring or autumn, it is assumed that a building heated by sunlight during the day represents a high temperature object, while a building cooled at night does not represent a high temperature object. Given that the season is winter, it is assumed that the temperature of a building will be less than 30° C. both during the day and at night so that the building does not represent a high temperature object.

The high temperature region detection unit 14B determines whether the current building is a high temperature object by using, for example, table information indicating a combination of the season (e.g., month and day) and the time zone during which the building represents a high temperature object. The high temperature region detection unit 14B may use different table information depending on the area. For example, the table information corresponding to a high latitude area may show relatively few combinations of the season and the time zone during which the building represents a high temperature object, and the table information corresponding to a low latitude area may show relatively more combinations of the season and the time zone during which the building represents a high temperature object.

The high temperature region detection unit 14B may further use the temperature information to determine whether a building included in the angle of view of the camera 30 represents a high temperature object. The high temperature region detection unit 14B may determine that the building represents a high temperature object in the case that, for example, the air temperature at the imaging position is equal to or higher than a predetermined value (e.g., 20° C. or 25° C.). The high temperature region detection unit 14B may determine that the building represents a high temperature object when the air temperature at the imaging position is equal to or higher than a predetermined value and the condition of the season and the time zone during which the building represents a high temperature object is met.

When the high temperature region detection unit 14B determines that the building included in the angle of view of the camera 30 represents a high temperature object, the high temperature region detection unit 14B detects the region in the angle of view of the camera 30 including the high temperature object as a high temperature region. The high temperature region detection unit 14B determines, for example, whether a building representing a high temperature object is included in each of the plurality of divided regions 42 shown in FIG. 2. The high temperature region detection unit 14B detects the divided region 42 including the building representing a high temperature object as a high temperature region.

According to this embodiment, a high temperature object included in the video can be detected by using information different from the video acquired by the video acquisition unit 12. According to this embodiment, it is possible to detect a person and a high temperature object other than the person in distinction from each other. This makes it possible to detect a high temperature region where a high temperature object other than a person is located in the background of the person. This embodiment also makes it possible to increase the accuracy of detection of a person located in a high temperature region by detecting the person located in the high temperature region by the second detection process. Meanwhile, the accuracy of detection of a person located outside the high temperature region can be increased by detecting the person located outside the high temperature region by the first detection process.

### Fourth Embodiment

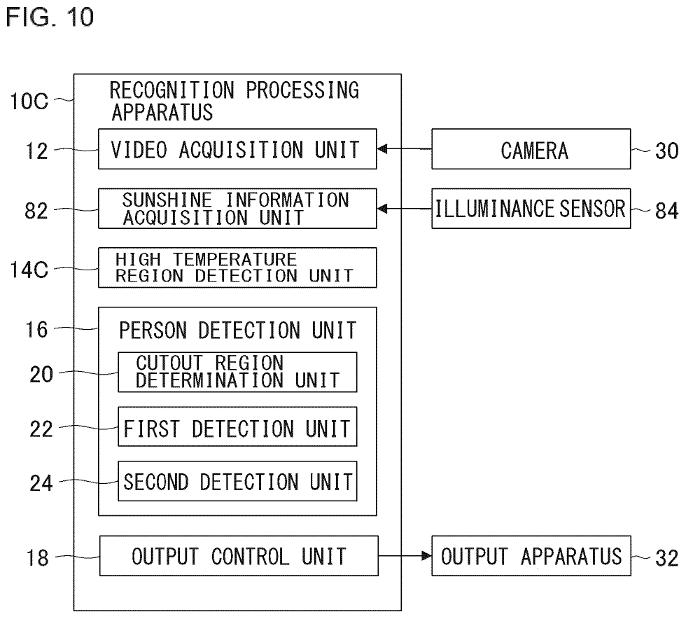

FIG. 10 is a block diagram schematically showing a functional configuration of a recognition processing apparatus 10C according to the fourth embodiment. The fourth embodiment differs from the above-described embodiments in that the recognition processing apparatus 10C further includes a sunshine information acquisition unit 82 and detects a high temperature region by using information acquired by the sunshine information acquisition unit 82. The recognition processing apparatus 10C according to the fourth embodiment acquires a video from the camera 30 fixed at a predetermined location such as a smart pole. Hereinafter, the fourth embodiment will be described, highlighting differences from the above-described embodiments, and a description of common features will be omitted as appropriate.

The recognition processing apparatus 10C includes a video acquisition unit 12, a sunshine information acquisition unit 82, a high temperature region detection unit 14C, and a person detection unit 16. The recognition processing apparatus 10C may further include an output control unit 18. The video acquisition unit 12, the person detection unit 16, and the output control unit 18 are configured in the same manner as in the first embodiment. The person detection unit 16 may be configured in the same manner as the person detection unit 16A according to the second embodiment.

The sunshine information acquisition unit 82 acquires sunshine information measured by an illuminance sensor 84. The illuminance sensor 84 is provided on a smart pole, etc. on which the camera 30 is installed. The illuminance sensor 84 measures the illuminance in the imaging range of the camera 30 and outputs sunshine information indicating the measured illuminance. The sunshine information acquisition unit 82 may acquire sunshine information determined based on the weather at the current location from an external server, etc. by using a wireless communication function (not shown).

The high temperature region detection unit 14C estimates a high temperature region including a high temperature object in the video acquired by the video acquisition unit 12, by using the sunshine information acquired by the sunshine information acquisition unit 82. For example, the high temperature region detection unit 14C estimates the temperature distribution in the imaging range of the video acquired by the video acquisition unit 12 by using the sunshine information and detects a region in the estimated temperature distribution, in which the temperature is equal to or higher than a predetermined threshold value, as a high temperature region. In the case that the camera 30 is fixed to a smart pole, etc., the imaging range of the camera 30 is fixed so that the temperature distribution of objects other than the person included in the imaging range (e.g., buildings and road surfaces) is mainly determined by sunshine. For example, the temperature distribution in the imaging range of the camera 30 can be estimated by using the sunshine information acquired by the sunshine information acquisition unit 82, by determining in advance the temperature distribution of objects other than the person included in the imaging range of the camera 30 as a function of the illuminance value. The high temperature region detection unit 14C can retain temperature distribution information in advance as a function of the illuminance value.

In the case that the camera 30 according to this embodiment is fixed to a smart pole, etc., for example, the person to be detected may be photographed from above the person. In such a case, the temperature of the road surface on which the person is located may become high due to sunshine, and the entire road surface in the background of the person may become a high temperature region. In such a case, the high temperature region detection unit 14C regards the entire background of the person (or the entire shooting range of the camera 30) as a high temperature region by using the sunshine information, and the person detection unit 16 detects the person by using the second detection process that uses the second detection unit 24.

In the case that the camera 30 is fixed to a smart pole, etc., the range detected as a high temperature region may be the entire shooting range of the camera 30 or may be a range marked as a road in the shooting range of the camera 30.

In this embodiment, the output control unit 18 may use the output apparatus 32 to transmit information on a person or a vehicle detected from the video captured by the camera 30 installed on a smart pole, etc. to a server that performs road-to-vehicle communication or a vehicle running in the vicinity.

According to this embodiment, a high temperature object included in the video can be detected by using information different from the video acquired by the video acquisition unit 12. According to this embodiment, it is possible to detect a person and a high temperature object other than the person in distinction from each other. This makes it possible to detect a high temperature region where a high temperature object other than a person is located in the background of the person. This embodiment also makes it possible to increase the accuracy of detection of a person located in a high temperature region by detecting the person located in the high temperature region by the second detection process. Meanwhile, the accuracy of detection of a person located outside the high temperature region can be improved by detecting the person located outside the high temperature region by the first detection process.

Each embodiment described above is applicable to a technology of detecting a person in a continuous video and tracking the person detected in the continuous video. When a person detected in a state where a high temperature object is not included in the background (i.e., outside the high temperature region) shifts to a state where a high temperature object is included in the background (inside the high temperature region) as a result of the movement of the person or the movement of the vehicle, etc., for example, the first person detection process by the first detection unit can be switched to the second person detection process by the second detection unit. As a result, a person can be continuously detected inside and outside the high temperature region, and the person can be tracked properly.

According to the present disclosure, a technology for detecting a person more properly in an image recognition process can be provided.

The present disclosure has been explained with reference to the embodiments described above, but the present disclosure is not limited to the embodiments described above, and appropriate combinations or replacements of the features presented in the embodiments are also encompassed by the present disclosure.

What is claimed is:

1. A recognition processing apparatus comprising:
a video acquisition unit that acquires a video captured by an infrared camera;
a high temperature region detection unit that detects a high temperature region included in the video;
a first detection unit that detects a person outside the high temperature region in the video by using a first detection process; and
a second detection unit that detects a person inside the high temperature region in the video by using a second detection process different from the first detection process.

2. The recognition processing apparatus according to claim 1,
wherein the first detection unit detects a person by using a first person detection model trained by machine learning that uses a person image that does not include a high temperature object in the background of the person as a correct answer image, and
wherein the second detection unit detects a person by using a second person detection model trained by machine learning that uses a person image that includes a high temperature object in the background of the person as a correct answer image.

3. The recognition processing apparatus according to claim 1,
wherein the second detection unit detects a person by using a video to which an image process that enhances contrast in the high temperature region in the video is applied.

4. The recognition processing apparatus according to claim 1,
wherein the high temperature region detection unit detects the high temperature region based on a luminance value of each of a plurality of divided regions set in the video.

5. The recognition processing apparatus according to claim 1,
wherein the high temperature region detection unit detects the high temperature region by using at least one of position information indicating an imaging position of the video, map information indicating a building located around the imaging position, time information indicating a date and time of imaging of the video, orientation information indicating an imaging direction of the video, or temperature information indicating a temperature at the imaging position of the video.

6. The recognition processing apparatus according to claim 1,
wherein the high temperature region detection unit detects the high temperature region by using sunshine information in an imaging range of the video.

7. A recognition processing method comprising:
acquiring a video captured by an infrared camera;
detecting a high temperature region included in the video; and
detecting a person by using a first detection process outside the high temperature region in the video and detecting a person by using a second detection process different from the first detection process inside the high temperature region in the video.

8. A non-transitory recording medium storing a program comprising processor-implemented modules including:
a module that acquiring a video captured by an infrared camera;
a module that detects a high temperature region included in the video;
a module that detects a person by using a first detection process outside the high temperature region in the video and detects a person by using a second detection process different from the first detection process inside the high temperature region in the video.
